(19) United States
(12) Patent Application Publication
(10) Pub. No.: US 2011/0114566 A1
(43) Pub. Date: May 19, 2011

(54) PROCESS AND APPARATUS FOR SEPARATING HYDROCARBONS FROM PRODUCED WATER

(76) Inventors: Dermot McCaw, Edmonton (CA); Jim Bowhay, Sundre (CA)

(21) Appl. No.: 13/054,274

(22) PCT Filed: Jul. 17, 2009
(86) PCT No.: PCT/CA2009/001024

§ 371 Date: Jan. 14, 2011

Related U.S. Application Data
(60) Provisional application No. 61/081,486, filed on Jul. 17, 2008.

(51) Int. Cl. C02F 1/24; B01D 17/035; C02F 1/40

(52) U.S. Cl. 210/703

(57) ABSTRACT

A process for removing hydrocarbons such as oil from produced water entrains high concentrations of very small gas bubbles within produced water inside a vertically-oriented primary separation tank by means of aerators immersed in the water inside the tank. Oil droplets coat the gas bubbles which form a buoyant oil-rich froth phase overlying a gas-rich liquid phase. The froth phase flows out through a discharge port in a preferably conical upper section of the primary tank, for disposal or recovery of oil as appropriate. Solid contaminants not borne by the froth phase may be intermittently settled out of the liquid phase and removed for treatment or disposal through a discharge port in a preferably conical lower section of the primary tank. Clean processed water is drawn a medial region of the primary tank for re-use as appropriate. In a preferred embodiment, the froth phase passes into a secondary separation tank for further separation of contaminants by means of gravity and/or supplemental aeration.

### FIELD OF THE INVENTION

The present invention relates in general to processes and apparatus for removing contaminants such as hydrocarbons and particulate matter from contaminated water, and in particular for separating oil and other hydrocarbons from produced water from oil and natural gas wells.

### BACKGROUND OF THE INVENTION

“Produced water” is a term commonly used in the oil and gas industry to describe water that is brought to the surface in the course of producing hydrocarbons (e.g., crude oil, natural gas, coalbed methane or “CBM”) from subsurface geologic formations in both land-based and offshore production operations. The exact composition of produced water will vary from case to case, but it will typically contain residual hydrocarbons (such as in the form of oil droplets) that are not readily separated from the well fluids during conventional surface-based processing operations. In addition, produced water contains various additional (and typically undesirable) constituents including dissolved metals and minerals, as well as suspended solids, in varying concentrations. Suspended solids may be in the form of sand, ultra fines, bitumen, wax, surfactants, detergent, iron oxides, etc.

The amount of produced water coming from a given well, relative to the amount of produced hydrocarbon fluids, as well as the concentration of the produced water's various non-aqueous constituents, will vary with many factors, including subsurface formation characteristics, recovery processes being used (i.e., whether such processes involve injection of water or steam), and how long the well has been producing (for example, “older” wells tend to produce higher amounts of produced water as a proportion of total produced fluids).

As a general rule, production water is not environmentally friendly due to the variety and typically significant amounts of non-aqueous constituents that it contains. Accordingly, produced water usually needs to be disposed of or else cleaned well enough to permit re-use for some beneficial purpose. In addition to the environmental and practical reasons which make it desirable to clean produced water for re-use (or for more environmentally-benign disposal), produced water's residual hydrocarbon content may in itself warrant processing produced water for the specific purpose of recovering residual hydrocarbons, and the economic viability of such processing of produced water will increase with decreases in the world's known petroleum reserves and increases in hydrocarbon prices.

For the foregoing reasons, there is a continuing need for new and more effective apparatus and processes for removing residual hydrocarbons and other contaminants from process water. The present invention is directed to this need.

### BRIEF SUMMARY OF THE INVENTION

In general terms, the present invention provides a process and apparatus for cleaning (or “polishing”) produced water (i.e., removing residual hydrocarbon content or other contaminants from produced water) by entraining high concentrations of small gas bubbles within a volume of produced water. Although described herein primarily in the specific context of removing oil or other hydrocarbons from produced water, it is to be understood that the methods and apparatus of the present invention may also be adapted to remove other types of contaminants from contaminated water sources other than produced water.

It is known that residual hydrocarbons or other contaminants can be removed from water by introducing small gas bubbles into the water. The bubbles adhere to the contaminants, and thus carry the contaminants to the water surface by flotation, allowing the contaminants to be removed by skimming or other suitable methods. One well-known application of this principle is the “dissolved air flotation” process (or DAF), which is widely used to treat various types of waste water. Such processes are not dependent on the use of any particular gas for generation of bubbles. Air, oxygen, natural gas, and nitrogen are examples of gases that can be used in DAF and similar processes.

The effectiveness of DAF and other dissolved gas flotation processes for removal of contaminants depends on bubble size, bubble concentration, and bubble distribution. In other words, optimal efficiency of contaminant removal is achieved by generating the smallest bubbles possible and distributing the bubbles as thoroughly and uniformly as possible in the water being treated, and in the densest concentration possible. Among the reasons why small bubbles are desirable is that small bubbles are less susceptible to agglomeration with other bubbles to form much larger bubbles, which are less effective in raising contaminants to the water surface. An additional and very significant reason is that smaller bubbles have been observed to have longer dwell times; i.e., they tend to take longer to rise to the water surface than larger bubbles. These characteristics make it easier for smaller bubbles to achieve concentrated and uniform distributions.

Known dissolved gas flotation processes typically generate bubbles externally from the vessel containing the water to be treated; in such cases, a stream of gas-saturated water is pumped into the treatment vessel. This methodology is not ideally conducive to the creation of optimally small bubbles or optimal bubble distributions, in part because the bubbles are more susceptible to breakdown or agglomeration into larger bubbles during transport to the treatment vessel.

In accordance with the method of the present invention, gas bubbles are generated inside the treatment vessel, and are thus introduced immediately and directly into the water being treated. The bubbles are created using an aerator disposed inside the treatment vessel and immersed in the water being treated. Moreover, the particular type of aerator used in preferred embodiments of the invention may be readily adapted to generate bubbles much smaller than the bubbles typically produced in known processes. In addition, the design of the aerator and its orientation in the treatment vessel are such that operation of the aerator to generate bubbles is also effective to mix the bubbles with optimal uniformity into the water in the vessel, thus maximizing the effectiveness of the bubbles in removing contaminants from water in all regions within the vessel. As well, the process vessels are geometrically configured to minimize the size of the oil-water interface (or contaminant-water interface) to facilitate removal of separated oil (or other contaminants) with minimal loss of water.

### BRIEF DESCRIPTION OF THE DRAWINGS

Embodiments of the invention will now be described with reference to the accompanying figures, in which numerical references denote like parts, and in which:

FIG. 1 is a schematic diagram of a water cleaning apparatus in accordance with an embodiment of the present invention.

FIG. 2 is an elevation and partial cross-section through a prior art aerator adaptable for use in association with the apparatus of the present invention.

FIG. 3 is a perspective of a water cleaning apparatus in accordance with an embodiment of the present invention, mounted on a transportable skid structure.

FIG. 4 is an elevation of the skid-mounted apparatus shown in FIG. 3.

FIG. 5 is an elevation of the gas induction tank of a single-tank alternative embodiment of the apparatus of the invention.

FIG. 6A is a plan view of a gas induction tank having two aerators mounted in skewed orientation relative to the vertical axis of the tank.

FIG. 6B is a plan view of a gas induction tank having four aerators mounted in skewed orientation relative to the vertical axis of the tank.

FIG. 7 is a histogram illustrating sample air bubble diameter and distribution in clean water, as determined using a prior art aerator generally as shown in FIG. 2 installed in a laboratory tank with a hydrostatic head of 2.0 meters.

FIG. 8 is a histogram illustrating cumulative air bubble distribution for laboratory test conditions as in FIG. 7, in terms of total bubble number and total bubble volume.

FIG. 9A is a histogram of the probability of air bubble diameter in clean water, for an aerator operating at 1750 rpm in a laboratory tank with a hydrostatic head of 2.0 meters.

FIG. 9B is a histogram of the probability of air bubble diameter in water having 120 parts per million (ppm) olive oil, for an aerator operating at 1750 rpm in a laboratory tank with a hydrostatic head of 2.0 meters.

FIGS. 10A and 10B are histograms of the probability of air bubble diameter in water having 500 ppm olive oil, for an aerator operating at 1750 rpm in a laboratory tank with a hydrostatic head of 1.1 meters and 2.0 meters, respectively.

FIG. 11 is a histogram of the probability of bubble diameter for water having 500 ppm olive oil in a static test, as measured 15 minutes and 30 minutes after sample extraction from a laboratory tank after aeration at 1750 rpm under a hydrostatic head of 2.0 meters.

FIG. 12 is a histogram of the cumulative distribution of bubble diameter for water having 500 ppm olive oil in a static test, as measured 15 minutes and 30 minutes after sample extraction from a laboratory tank after aeration at 1750 rpm under a hydrostatic head of 2.0 meters.

### DETAILED DESCRIPTION OF THE PREFERRED EMBODIMENTS

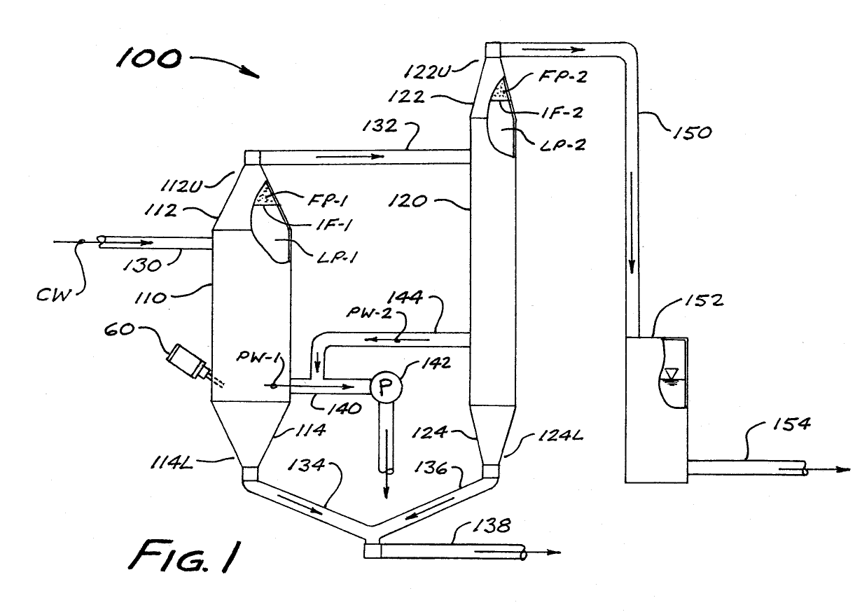

The process of the present invention may be understood with reference to FIG. 1, which is a schematic depiction of a first embodiment 100 of the apparatus of the invention. Apparatus 100 includes a generally cylindrical and vertically-oriented gas induction tank, referred to herein as primary separation tank 110. Primary tank 110 includes a preferably conical upper section 112 (having an upper end 112U) and a preferably conical lower section 114 (having a lower end 114L). Apparatus 100 further includes a generally cylindrical and vertically-oriented secondary separation tank 120 having a preferably conical upper section 122 (with upper end 122U) and a preferably conical lower section 124 (with lower end 124L). A feed water inlet conduit 130 (preferably but not necessarily in the form of a rigid pipeline) is in fluid communication with a preferably medial or upper region of the cylindrical main portion of primary tank 110, for purposes of introducing process water into the interior chamber of primary tank 110. An upper outflow conduit 132 extends between upper end 112U (of upper section 112 of primary tank 110) and an upper region of the cylindrical main portion of secondary tank 120, for purposes of allowing a contaminant-laden froth phase (as described later herein) to flow from upper section 112 of primary tank 110 into secondary tank 120. In preferred embodiments, upper outflow conduit 132 is specially designed to promote laminar (i.e., non-turbulent) flow, in accordance with methods well known in the art.

As shown in FIG. 1, a primary solids discharge conduit 134 is connected to lower end 114L of lower section 114 of primary tank 110, and a secondary solids discharge conduit 136 is connected to lower end 124L of lower section 124 of secondary tank 120, both of these solids discharge conduits being for purposes of directing settled solids from primary and secondary tanks 110 and 120 to appropriate treatment or disposal means. The angle of the conical walls of lower section 114 of primary tank 110 and lower section 124 of secondary tank 120 is preferably in the range of 45 to 60 degrees from horizontal to promote flow of settled solids. Primary and secondary solids discharge conduits 134 and 136 may optionally merge and connect to a main solids discharge conduit 138 as shown.

A primary polished water (i.e., clean water) discharge conduit 140 extends from a lower region of the cylindrical main portion of primary tank 110, typically with a polished water discharge pump 142 being connected at a selected point along primary clean water conduit 140. A secondary clean water discharge conduit 144 extends from a lower region of the cylindrical main portion of secondary tank 120, and may optionally connect into primary clean water conduit 140 at a point between primary tank 110 and pump 142.

A contaminants recovery conduit 150 extends from upper end 122U of upper section 122 of secondary tank 120, for conveying recovered liquid hydrocarbons or other contaminants to suitable treatment or collection means (such as, for example, an oil storage tank 152 as illustrated in FIG. 1, which may have a discharge conduit 154 for conveying the recovered oil to a sales or treatment facility).

Apparatus 100 also incorporates at least one aerator means mounted in association with primary tank 110 for entraining gas bubbles in an aqueous liquid within primary tank 110. In preferred embodiments of apparatus 100, the aerator means is an aerator 60 constructed in accordance with the teachings of Canadian Patent No. 1,328,028 (Rymal) and corresponding U.S. Pat. No. 4,732,682 (which is incorporated herein by reference). The Rymal aeration apparatus has been found to be particularly effective producing high concentrations of very small and long-lasting gas bubbles within an aqueous liquid, characteristics which are particularly beneficial for purposes of the process of the present invention, as will be explained herein.

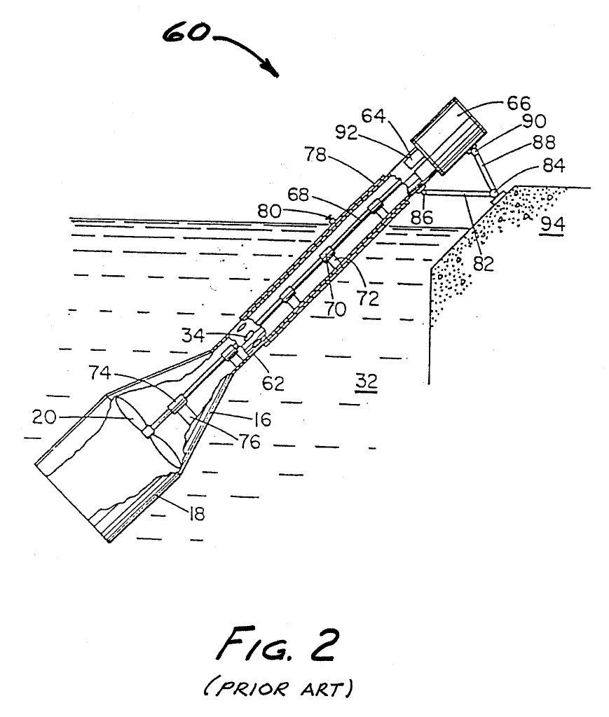

FIG. 2 illustrates an embodiment of the prior art aerator taught by CA 1,328,028 and U.S. Pat. No. 4,732,682. Although the construction of aerator 60 for purposes of preferred embodiments of apparatus 100 of the present invention will not necessarily be identical to this illustrated embodiment, FIG. 2 aptly depicts the basic features of aerator 60. As shown in FIG. 2, aerator 60 includes an outer housing 12 having a smaller-diameter cylindrical gas inlet section 62, an intermediate conical section 16, and a larger-diameter cylindrical discharge section 18. A propeller 20 is rotatably mounted adjacent the larger-diameter end of conical section 16, and is driven by an electric (or hydraulic) motor 66 through a drive shaft 68.

FIG. 2 shows aerator 60 installed in association with an open-top tank full of water, with aerator 60 oriented at an angle of approximately 45 degrees, and with housing 12 being entirely submerged in the water. As noted in CA 1,328,028 and U.S. Pat. No. 4,732,682, it has been found that installation of aerator 60 with its central axis inclined at an angle between 30 and 60 degrees promotes an enhanced mixing effect.

In a region proximal to conical section 16, cylindrical inlet section 62 of housing 12 has a plurality of water inlets 34, such that when aerator 60 is immersed in water, water can flow through inlets 34 and into conical section 16 of housing 12 upstream of propeller 20. The flow of water through inlets 34 may be regulated by selective positioning of a sleeve 78 which is slidably disposed around inlet section 62 such that it can partially or completely cover inlets 34 as desired. Persons skilled in the art will of course appreciate that other suitable water inflow regulation means can be readily devised in accordance with known technologies.

In the prior art aerator shown in FIG. 2, the upper (i.e., outer) end of inlet section 62 is provided with a plurality of air inlets 64, whereby air can enter inlet section 62. Accordingly, when aerator 60 is immersed in water as shown, with the upper end of inlet section 62 extending above the water surface and with water inlets 34 at least partially open, actuation of motor 66 will cause rotation of propeller 20, which in turn will draw air through into conical section 16 via inlet section 62. The rotation of propeller 20 thus causes mixing of water and air to produce an air-water froth which is discharged from the large open end of cylindrical discharge section 18 of housing 12. Continued rotation of propeller 20 promotes uniform dispersal of bubbles within the mass of water.

As noted in CA 1,328,028 and U.S. Pat. No. 4,732,682, aerator 60 can be readily adapted to entrain gases other than air within water or other liquids, rather than simply using atmospheric air as in the embodiment of FIG. 2. This can be accomplished in various ways, such as by running gas lines from an external gas source through inlet section 62 to a selected gas discharge point upstream of propeller 20.

Although preferred embodiments of the apparatus incorporate aerators in accordance with the teachings of CA 1,328,028 and U.S. Pat. No. 4,732,682, it is to be clearly understood that the scope of present invention is not limited to the use of such specific types of aerators. Persons skilled in the art will readily appreciate that the present invention may be adapted for use with other types of aerators and aeration technologies capable of generating gas bubbles of suitable size and distribution within a water-filled process vessel, in a manner generally as described herein.

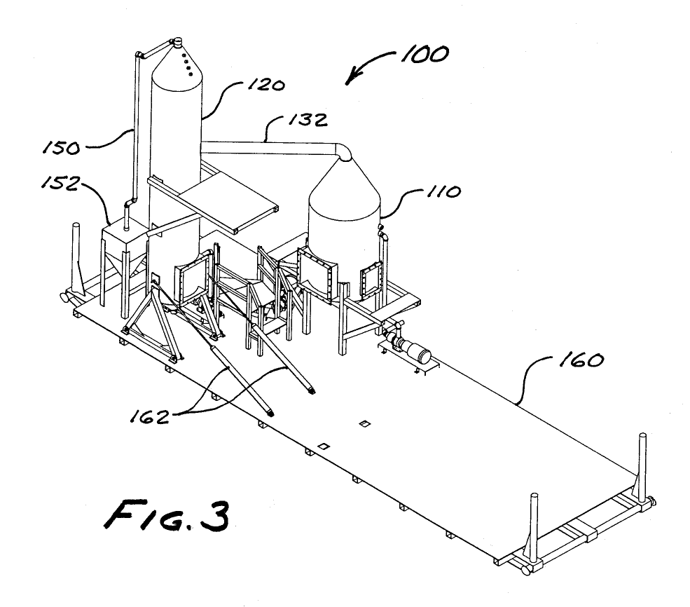

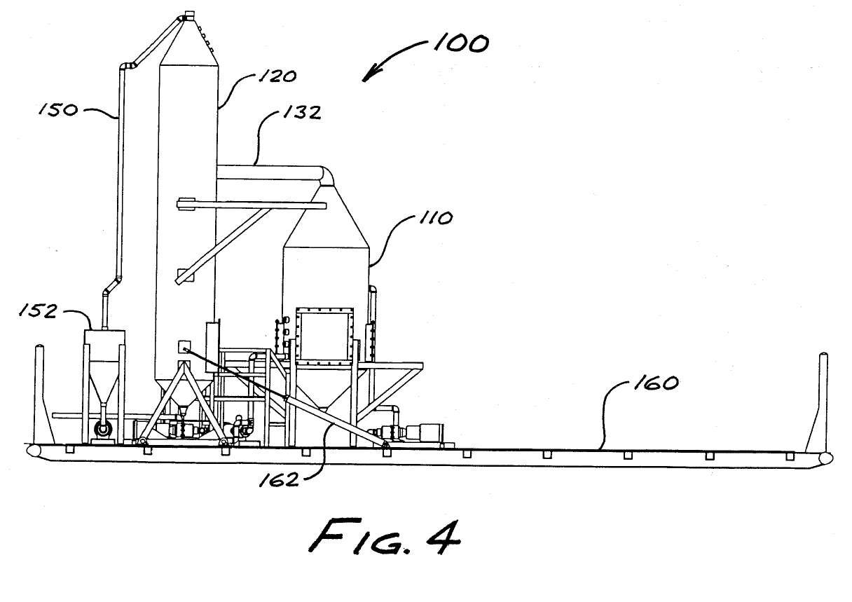

As schematically illustrated in FIG. 1, apparatus 100 includes at least one aerator 60 mounted through the sidewall of primary tank 110, at a selected point below (and preferably well below) the connection of feed water inlet 130. Each aerator 60 is oriented at a selected angle between 30 and 60 degrees from vertical, with the preferred orientation being approximately 45 degrees. Each aerator 60 is preferably disposed almost entirely within primary tank 110, with motor 66 being located outside primary tank 110. In preferred embodiments, the plan-view orientation of each aerator 60 is also skewed relative to the vertical axis of primary tank 110 (as illustrated by way of example in FIGS. 6A and 6B). This skewed orientation causes the discharge of bubbles from aerators 60 to induce a swirling flow within primary tank 110, thereby further enhancing the thoroughness of bubble distribution within the produced water. In preferred embodiments, the aerator skew angle 60A (i.e., the angle between the axis of the aerator and the vertical axis, as viewed in plan) is approximately 15 degrees, as shown in FIGS. 6A and 6B. However, larger or smaller aerator skew angles may alternatively be used to beneficial effect.

In alternative embodiments of apparatus 100, aerator 60 could incorporate air inlets 64 as shown in FIG. 2. However, preferred embodiments of the process of the present invention use nitrogen (or another inert gas) to generate bubbles in process water within primary tank 110 rather than air or oxygen (the use of which would constitute a potential risk of explosion due to the hydrocarbon content in the process water). Accordingly, preferred embodiments of apparatus 100 will incorporate an aerator 60 having gas lines from an external gas source (such as a nitrogen storage bottle) for delivering gas to a selected point upstream of propeller 20. From a technical standpoint, hydrocarbon gases such as methane, ethane, or propane could also be effectively used for aeration in the present process. However, inert aeration gases are preferred in view of potential fire and explosion hazards associated with inflammable gases, and to avoid the risk of such “greenhouse gases” being released into the atmosphere.

To implement the process of the present invention using the apparatus 100 as shown in FIG. 1 to clean or “polish” contaminated water (such as but not restricted to produced water), a flow of contaminated water CW is introduced into primary tank 110 through feed conduit 130. The one or more aerators 60 are actuated in conjunction with a flow of aeration gas (such as but not restricted to air or nitrogen), so as to cause the water in primary tank 110 to become highly saturated with gas bubbles. As previously noted, the one or more aerators 60 are angularly oriented such that the gas bubbles are directed both downwardly and inwardly into the produced water in primary tank 110, to promote optimal mixing and distribution of the bubbles within the produced water. In preferred embodiments, the orientation of each aerator 60 is also skewed relative to the vertical axis of primary tank 110. This skewed orientation causes the discharge of bubbles from the aerators 60 to induce a swirling flow within primary tank 110, thereby further promoting thorough and uniform bubble distribution.

As additional contaminated water CW enters primary tank 110 via feed water inlet 130, it is immediately mixed into the gas-saturated water already in primary tank 110. Suspended or emulsified contaminants in the produced water (such as but not limited to oil and particulate matter) adhere to the gas bubbles. The contaminant-laden bubbles rise within primary tank 110 due to natural buoyancy forces, resulting in formation of a contaminant-laden froth phase FP-1 lying above a gas-rich liquid phase LP-1. The total volumetric flows into and out of primary tank 110 are preferably balanced to keep the interface IF-1 between the froth phase and the liquid phase at a desired and relatively constant elevation within of primary tank 110. Preferably, interface IF-1 will occur in an upper region of conical upper section 112 in order to minimize the area of interface IF-1 and promote removal of froth phase FP-1 through upper outflow conduit 132 with minimal or no loss of liquid phase LP-1. Another benefit of a relatively constant froth/liquid interface is that it maintains a constant hydrostatic head within the tank, which is significant because the hydrostatic head affects gas bubble size and distribution (as discussed later herein).

In alternative embodiments, the process of the invention may use a primary separation tank having a geometric configuration different from that of the illustrated primary tank 110. For optimal process performance, however, it is highly preferable for the upper section of primary tank 110 to be conical as shown, for practical reasons including those discussed above. Preferably the sidewall of conical upper section 112 is at an angle between 45 and 80 degrees from horizontal.

Concurrent with froth phase removal through upper outflow conduit 132, substantially clean or polished water PW-1 is drawn out of primary tank 110 through primary clean water discharge conduit 140. Preferably, polished water PW-1 is sampled by suitable sensor or probe means associated with clean water discharge conduit 140. If polished water PW-1 does not meet prescribed or desired quality standards, it can be re-routed back into primary tank 110 to be re-polished.

Solid contaminants that are too dense to be lifted by the gas bubbles will tend to be kept in suspension by the swirling motion within primary tank 110. When such suspended solids accumulate to a predetermined level, a solids dump may be initiated by temporarily deactivating aerators 60 to stop the swirling motion and thus allow the solids to settle within primary tank 110. The settled solids are then removed via primary solids discharge conduit 134, and the process is returned to normal operation by reactivating aerators 60.

In the embodiment shown in FIG. 1, further separation of hydrocarbons and other froth-borne contaminants takes place within secondary separation tank 120. As shown in FIG. 1, the contaminant-laden froth phase FP-1 flows into an upper region of secondary tank 120 via upper outflow conduit 132. Due to their comparatively very small sizes, the bubbles in froth phase FP-1 do not tend to break down to a substantial extent during flow into secondary tank 120. In one embodiment of apparatus 100, secondary tank 120 is essentially a gravity-type separation vessel, with no agitation or circulation means provided. The froth phase FP-1 flowing into secondary tank 120 from primary tank 110 tends to separate naturally into a second froth phase FP-2 overlying a second liquid phase LP-2 within secondary tank 120, with a second froth-phase/liquid phase interface IF-2 therebetween. The second froth phase FP-2 flows out of secondary tank 120 through a contaminants recovery conduit 150 located at or near the top of secondary tank 120. A second polished water fraction PW-2 flows out of secondary tank 120 through secondary clean water discharge conduit 144.

Similar to the operation of primary tank 110, second froth/liquid interface IF-2 in secondary tank 120 is preferably maintained at or near a desired elevation within upper conical section 122 of secondary tank 120. This can be accomplished, for example, by means of a capacity probe controlling actuated valves and variable-speed pumps associated with feed water inlet 130, outflow conduit 132, and primary and secondary clean water discharge conduits 140 and 144. Sight glasses may also be installed to enable visual monitoring of interface levels. Maintenance of a constant froth/liquid interface IF-2 in secondary tank 120 causes the contaminant-laden second froth phase FP-2 to flow automatically into contaminants recovery conduit 150 and thence into a recovery tank 152 or other suitable treatment or collection means.

In alternative embodiments, the effectiveness of the process may be enhanced by providing secondary tank 120 with one or more supplementary aerators, mounted to secondary tank 120 in generally the same manner described in connection with the aerators 60 mounted in primary tank 110.

Dumping of solids from primary and secondary tanks 110 and 120 is preferably facilitated by providing a tuning fork-style capacity probe at a selected level near the top of the cone bottom of each tank. When the probe senses a high level of suspended solids inside one or both tanks, it will slow down (or shut down) the one or more aerators 60, and close the actuated valves on the relevant inlet and discharge conduits. A short settling time will allow suspended solids to settle to the bottom of the tanks. Due to the cone bottom tank designs and the hydrostatic head due to water in the tanks, settled solids are readily flushed out of the tanks (and into primary and secondary solids discharge conduits 134 and 136) upon opening of the corresponding discharge valves, with minimal loss of water from the tanks. This results in the formation of a clean solids/polished water slurry which will pass through a flow meter and thence to a suitable solids recovery or treatment facility.

The dumping of solids from primary and secondary tanks 110 and 120 is a timed event. The actuated inlet valve will open and the aerators will start to speed up as the actuated solids-control valve opens. This arrangement serves two purposes. First, it offsets the volume of water discharged with the solids, thus ensuring that froth/liquid interface IF-1 does not drop below the level of feed water inlet conduit 130. Second, it promotes process efficiency by ensuring that the system is restored to normal operational mode as soon as possible after completion of the solids discharge procedure.

Having due regard to environmental issues and other practical concerns, the process of the present invention have been developed as a closed-loop system with built-in redundancies to protect against spills of either oil or contaminated water:
Recovery tank 152, when used, is preferably equipped with a high-level shutdown. Should the level of liquid (such as recovered oil) reach the high-level shutdown, it will close the actuated inlet valve, thus stopping the process.
Aerators 60 preferably have a dual seal system. If the first seal ever fails, a capacity probe located between the seals will detect fluid and shut down the actuated inlet valve, thus stopping the process.
Aerators 60 preferably use nitrogen from a molecular sieve nitrogen generator to supply nitrogen into primary tank 110. As well, the top of primary tank 110 is preferably vented to facilitate proper discharge of solids. Both of these vents are tied together and controlled with a check valve.
As well, secondary tank 120 and recovery tank 152 are preferably tied together and controlled with a check valve. All of the air vents are tied into a condensation trap. If any of the check valves fail, any liquid will be caught in the condensation trap. A capacity probe is located near the top of the condensation trap. If the probe senses fluid, it will shut down the actuated inlet valve, thus stopping the process.

FIGS. 3 and 4 illustrate an alternative embodiment of apparatus 100 mounted on a transportable skid structure 160. This skid-mounted embodiment facilitates quick set-up of apparatus 100 in field locations, and will typically be housed within a suitable building enclosure (not shown) built atop and anchored to skid structure 160. The embodiment in FIGS. 3 and 4 includes optional hydraulic ram means 162 for rotating secondary separation tank 120 into a horizontal position during transport or when otherwise not in use.

Although optimal separation of oil and other contaminants from process water and other contaminated aqueous feedstocks will typically be best achieved using a two-tank apparatus as described above and illustrated in FIGS. 1, 3, and 4, alternative embodiments of the process and apparatus of the present invention are capable of effective contaminant removal using only a single separation tank. FIG. 5 illustrates one such alternative single-tank embodiment 200 of the apparatus, comprising separation tank 210, having a generally conical upper section 212 (having an upper end 212U), a generally conical lower section 214 (having a lower end 214L), feed water inlet port 230, solids discharge port 234, and clean water discharge port 240. One or more aerators 60 are mounted into separation tank 210 in a fashion generally as previously described in connection with primary tank 110 of embodiment 100 of the apparatus. An upper discharge conduit 232 is connected to an upper region of conical upper section 212 (preferably in association with a condensation trap 250), for removal of recovered oil or other contaminants.

In prototype testing, apparatus in accordance with the present invention was shown to provide a high-efficiency oil separator capable of processing approximately 600 cubic meters per day of a 1%-2% oil/water mixture. The apparatus and process can be readily adapted to achieve higher processing rates.

### Separation Mechanism and Related Considerations

The precise mechanism by which the process of the present invention removes oil (and other contaminants) from contaminated water such as process water has not been conclusively determined from a scientific standpoint. However, based on extensive investigation and testing conducted in a Canadian university mechanical engineering department, a plausible hypothesis has been developed.

It is apparent that the ability of gas bubbles to attract and transport contaminants in an aqueous liquid is to a significant degree a function of bubble size. The physics of bubble formation in water and the formation of oil-coated gas bubbles in a single-phase liquid medium may be generally understood from Appendix “A” attached to this specification (and titled, “Bubble size and pressure relations”). To understand the characteristics of the gas bubbles generated in accordance with the present invention, measurements were made of the diameter of the bubbles produced by an aerator operating in a laboratory on a prototype tank at a motor speed of 1750 rpm, using Phase Doppler Anemometry (PDA). This technique was selected because it is non-intrusive (i.e. direct measurements can be made inside the tank, without extraction of fluid) and, when operated in back-scatter reflection mode, it is independent of the air or oil index of refraction. The parameters investigated included the influence of the hydrostatic head and oil concentration. Static samples on extracted fluid were also tested to determine the influence of time. Results are based on at least 10,000 samples for each test.

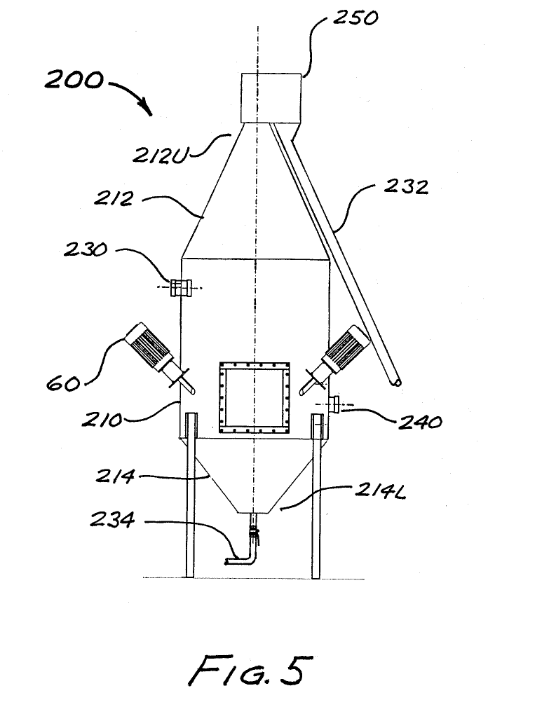

Initial measurements were made at various locations inside a laboratory tank filled with clean water, with either one or aerators motors operating under a constant hydrostatic head. Sample results from these initial tests are presented in FIG. 7. The results showed no statistically significant variation of bubble size distribution inside the tank, indicating that mixing was quite thorough such that above the aerator level the bubble size distribution does not appear to depend on location.

Typically, the bubble size distribution fell into three classes. As may be seen from FIG. 7, the first class contained bubbles typically with diameters dₚ ranging from zero to 20 microns (μm), with peaks around 6 μm to 8 μm, while the second class of bubbles had diameters dₚ ranging from 100 μm to 130 μm. As can be seen in FIG. 8, about 95% of the bubbles measured were in the smaller class. The total volume of the bubbles, however, was greater for the second class (note that bubble volume varies with the third power of bubble diameter dₚ). Although the PDA measurement range was limited to sizes not exceeding 150 μm, a third class of bubbles was also observed, having diameters typically in the range of several millimetres up to a centimeter. These much larger bubbles were few in number.

Tests were also conducted for clean water at the conditions stated above but for different hydrostatic heads. The general distribution of the bubble classes appeared to be unaffected. However, it was observed that as the hydrostatic head increased, the average size of the smaller bubble class increased slightly and the peak distribution increased monotonically from approximately dₚ≈7 μm at a head of 1.1 meters to approximately dₚ≈9 μm at a head of 2.0 meters. The second class bubble distribution appeared to be unaffected by variations in hydrostatic head.

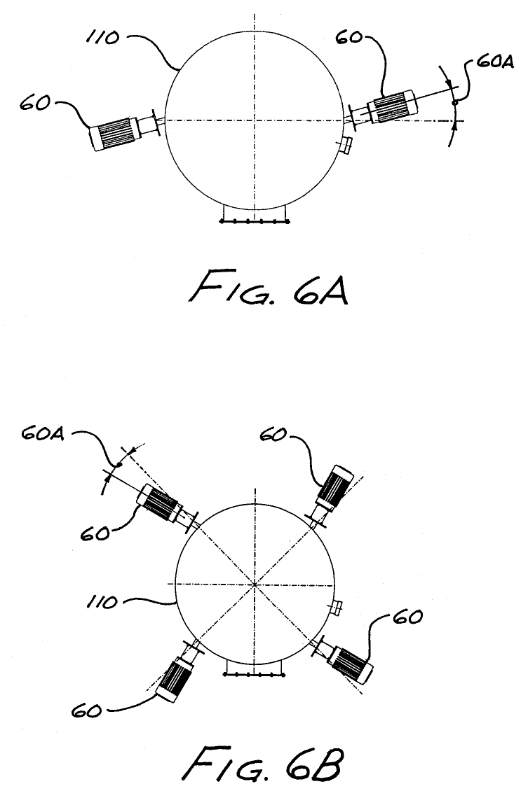

FIGS. 9A and 9B present representative bubble size measurement test results for a constant head of 2.0 meters in the laboratory tank facility for clean water (FIG. 9A) and for water containing 120 parts per million (ppm) of oil. In these tests, olive oil was used to simulate hydrocarbons, as olive oil has approximately the same density and surface tension characteristics. These test results suggest as the following conclusions:
As oil concentration increases, the relative proportion of the larger (i.e., second) class of bubbles (dₚ≈120 μm) increases relatively to the smaller (i.e., first) class.
Bubble size distribution in the smaller class broadens when oil is present, and small but significant numbers of bubbles with diameters in the range between the two classes appear, suggesting coalescence.
There appeared to be no significant difference between bubble size distribution results when using one as opposed to two aerators.

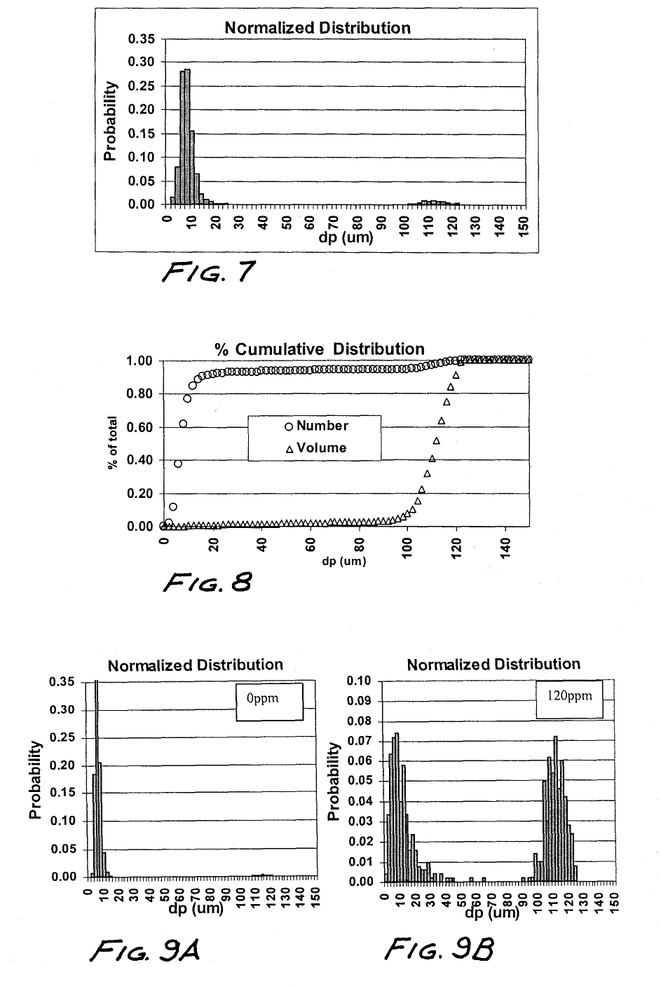

FIGS. 10A and 10B illustrate laboratory measurements of bubble size distribution as a function of the hydrostatic head for an average concentration of 500 ppm olive oil, for hydrostatic heads of 1.1 meters (FIG. 10A) and 2.0 meters (FIG. 10B). In general, the trends for the small bubble size classes were similar to those observed for clean water; i.e., a slight increase in the bubble diameter as hydrostatic head is increased. The broadening of the distribution is greater for the higher hydrostatic head. These results are consistent with the previous inference that the smaller bubbles undergo coalescence while the larger bubbles form nucleation points to accumulate oil.

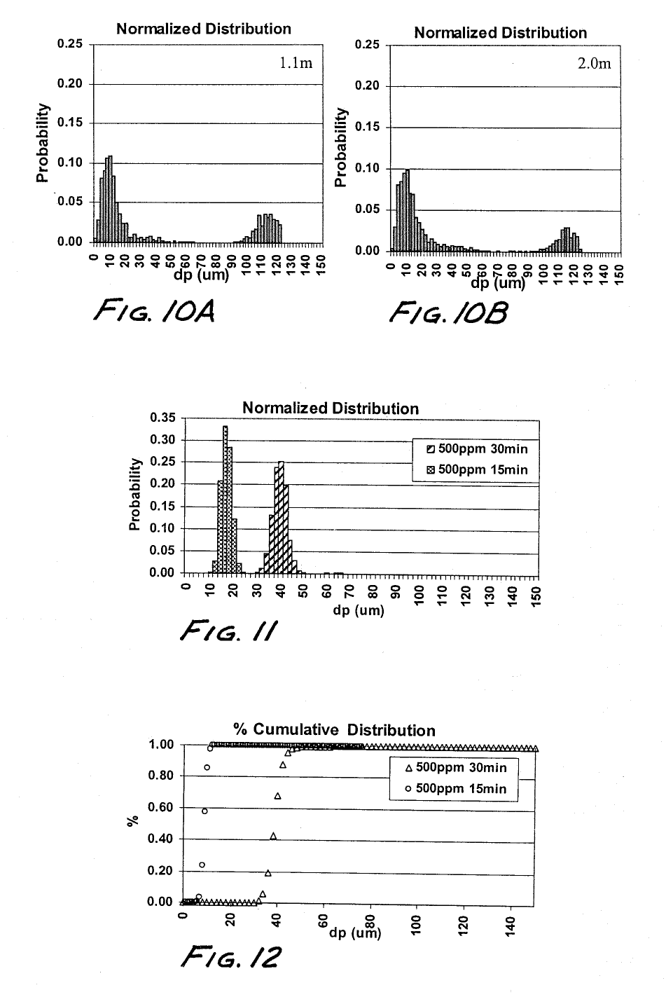

Bubble size measurements were also conducted on a sample extracted from the bottom of the laboratory tank. Measurements were done for oil concentrations of 500 ppm at 15 minutes and 30 minutes after sample extraction, and the results are presented in FIGS. 11 and 12. The purpose of these particular measurements was partly to determine whether a static sample was representative of the process in the tank and partly to observe changes with time. The results indicate a significant change with time in the bubble size distributions (compared to FIGS. 9A and 9B). It may also be observed that only a single class of bubbles remained in static samples either 15 minutes or 30 minutes after sample extraction and, furthermore, that the size of the bubbles increased with time and the bubble size distribution broadened.

The larger bubble sizes can be expected to rise very quickly, so it is not unexpected that the larger bubbles would quickly disappear from the sample area. The smaller bubbles, however, have a very low rise velocity. These results thus indicate that the smaller bubbles undergo coalescence, which would appear explain both the disappearance of the smaller bubble size class and the increase in the average bubble size.

In the bubble size measurements summarized above, it may be noted that in the clean water tests, the large-size bubble class remains small, while for the oil-water system there is clearly an increase in the relative proportion of larger bubbles. The process of coalescence would explain this process. However, a few points should be observed in relation to the surface tension. Referring to Appendix “A”, the surface tension of the oil-coated bubbles in water is nearly identical to the water-air surface tension, such that oil-coated bubbles would tend to have the same size as non-coated bubbles. However, the oil-air surface tension is much lower—about one-third of the water-air surface tension. Thus, when two bubbles come in contact, the surface forces for oil-coated bubbles would be much lower than for non-coated bubbles. Hence, oil-coated bubbles would tend to coalesce more effectively. By the same reasoning, oil droplets contacting an uncoated air bubble would tend to coat the air bubble quickly (which further suggests the importance of small bubbles in the process of the present invention).

Having regard to the laboratory bubble measurement program summarized above, the following hypothesis may be suggested with respect to the separation process of the present invention:
1. The separation process appears to occur in two stages. The first or initial stage involves interaction of the smaller bubbles and the mid-range bubbles. The smaller bubbles (dₚ<20 μm) have a high oil collection efficiency. The smaller bubbles give rise to larger surface tension forces due to their smaller diameters (see Eq. C.1 in Appendix “A”) and are thus more easily wetted by the small oil droplets. Typically, the collection efficiency seems to be best when bubbles are about the same size as the primary oil droplets. These bubbles have a very low rise velocity and, since they have a small diameter, collect only small volumes of oil. The separation process must thus be enhanced by coalescence and increased transport.
2. The small oil-coated bubbles coalesce and are collected by the medium-sized class of class bubbles (100 μm<dₚ<120 μm). The larger bubbles offer a greater surface area for attachment and are more buoyant (and thus have a much shorter rise time). Thus, the collection efficiency of the initial separation process depends on the proportional volumetric balance of the two classes of bubbles produced.
3. The flow at the exit of the aerator impinges on the tank walls and is redirected mainly towards the surface (i.e., in a rising plume). This motion results in a rapid convective current to the surface, which can rapidly (in the order of several seconds) transport micron-size bubbles to the surface. This motion also results in good mixing in the tank, which helps increase the contact of unseparated oil droplets with gas bubbles.
4. The role of the third (largest) class of bubbles is unclear. These are very large and likely do not interact with the smaller bubbles to a significant degree due to hydrodynamic effects (e.g., slip and local flow distortion). However, these larger bubbles can generate convective currents and entrainment which may help concentrate the smaller bubbles in their wakes and enhance lift.
5. The actual volume throughput for each of the bubble classes is inversely proportional to the bubble size. However, this observation may be somewhat misleading, as the separation process depends on the available contact surface area. Thus, the smaller bubble classes participate more in the initial separation process.
6. At the surface, the upward speed of the rising bubble plume is damped by the action of the free surface and oil. In this region, the flow is quite complex, but it is expected that the rise velocity becomes important, giving rise to assisted gravitational separation. Observations of the process suggest that a secondary separation must occur at the surface. Although this process has not been scientifically investigated, it is hypothesized that surface tension effects at the free surface and dead-water zones in the tank play a role in the final separation stages, and help keep oil concentration high at the surface.
7. The fluid inside the tank in laboratory tests was observed to be fully mixed. In the lower sections of the tank, the bubble distribution was very uniform and the bubble rise velocity appeared to be mainly a result of convection and bulk transport. However, at the free surface, the damping action of the water surface appears to slow down the process and gravitational effects appear to become more significant.

It can be expected that the separation process will be affected by the process temperature, which will primarily impact viscosity and surface tension properties of the liquid phase (oil and water). Although no scientific testing has been carried out on the issue, some trends may be predicted based on fundamental physical considerations. The initial separation process depends on the surface tension of the water-gas, water-oil and oil-gas interfaces. These are related through the spreading coefficient as indicated in Equation C.6 set out in Appendix “A”. A surface spreading coefficient near or below zero allows wetting of gas bubbles by oil droplets. Generally, the lower the spreading coefficient (especially at values less than zero), the faster and more efficient the coating process. As the temperature rises, the oil-gas and oil-water surface tensions decrease more rapidly than the water-gas surface tension. Accordingly, wetting occurs more easily and it is expected that the initial separation process will be more efficient with increased temperature (see Table C.2 in Appendix “A”).

It will be readily appreciated by those skilled in the art that various modifications of the present invention may be devised without departing from the scope and teaching of the present invention, including modifications which may use equivalent structures or materials hereafter conceived or developed. It is to be especially understood that the invention is not intended to be limited to any described or illustrated embodiment, and that the substitution of a variant of a claimed element or feature, without any substantial resultant change in the working of the invention, will not constitute a departure from the scope of the invention. It is also to be appreciated that the different teachings of the embodiments described and discussed herein may be employed separately or in any suitable combination to produce desired results.

In this patent document, any form of the word “comprise” is to be understood in its non-limiting sense to mean that any item following such word is included, but items not specifically mentioned are not excluded. A reference to an element by the indefinite article “a” does not exclude the possibility that more than one of the element is present, unless the context clearly requires that there be one and only one such element. Any use of any form of the terms “connect”, “engage”, “attach”, or any other term describing an interaction between elements is not meant to limit the interaction to direct interaction between the subject elements, and may also include indirect interaction between the elements such as through secondary or intermediary structure. Relative and relational terms such as “parallel”, “perpendicular”, “vertical”, and “horizontal” are not intended to denote or require absolute mathematical or geometrical precision. Accordingly, such terms are to be understood as denoting or requiring substantial precision only (e.g., “substantially parallel”) unless the context clearly requires otherwise.

### APPENDIX “A”

### Bubble Size and Pressure Relations

### Gas Bubbles in Single Phase Liquid Medium:

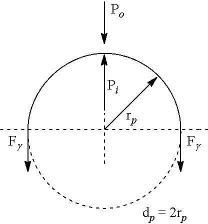

Pₒ=External pressure (of liquid)
Pᵢ=Internal Pressure (of gas)
γ=Gas-liquid interstitial (surface) tension
dₚ=Bubble diameter

The bubble size is a balance between the external pressure force and the external pressure force and the surface tension.

$${P}_{i} \cdot \frac{π {d}_{p}^{2}}{4} = {P}_{o} \cdot \frac{π {d}_{p}^{2}}{4} + {F}_{γ} \\ {F}_{γ} = γ \cdot π {d}_{p} \\ Thus \text{:} {P}_{i} - {P}_{o} = \frac{4 γ}{{d}_{p}} \qquad ( C .1 )$$

### Change in Bubble Size Due to Change in External Pressure:

Assuming that a bubble forms with a given diameter, dₚ₁, in an external pressure of Pₒ₁. If this bubble is now placed in an external pressure of Pₒ₂, its diameter will adjust to dₚ₂ to balance the forces. The internal increase in pressure will be regulated by the ideal gas law. Since the heat transfer to a liquid environment is rapid, isothermal conditions can be assumed. Hence, the adjustment of the bubble must satisfy the following relations:

Force:

$${P}_{i 1} - {P}_{o 1} = \frac{4 γ}{{d}_{p 1}} \\ {P}_{i 2} - {P}_{o 2} = \frac{4 γ}{{d}_{p 2}} \qquad ( C .2 )$$

Ideal gas law:

$${ρ}_{1} = \frac{{P}_{i 1}}{{RT}_{1}}$$

$${ρ}_{2} = \frac{{P}_{i 2}}{{RT}_{2}} ;$$

R is the gas constant

Since the mass of gas is constant inside the bubble:

$${m}_{1} = {ρ}_{1} \frac{π {d}_{p 1}^{3}}{6} = {m}_{2} = {ρ}_{2} \frac{π {d}_{p 2}^{3}}{6}$$

Thus combining the ideal gas law (noting that T₁=T₂) with the constant mass condition, one obtains that:

$$\frac{{d}_{p 1}^{3}}{{d}_{p 2}^{3}} = \frac{{P}_{i 2}}{{P}_{i 1}}$$

Combining this result with Eq. (C.2):

$${d}_{p 2}^{3} + \frac{4 γ {d}_{p 2}^{2}}{{P}_{02}} = \frac{{P}_{i 1}}{{P}_{o 2}} {d}_{p 1}^{3} \qquad ( C .3 )$$

Equation (C.3) is then to be solved to obtain dₚ₂ at the new pressure condition.

### Oil-Coated Gas Bubbles in Single Phase Liquid Medium:

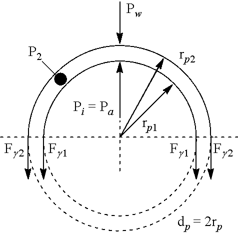

Pₒ=External pressure (of liquid)
Pᵢ=Internal Pressure (of gas)
γ=Gas-liquid interstitial (surface) tension
dₚ=Bubble diameter

The bubble size is a balance between the external pressure force and the external pressure force and the surface tension. When the gas phase is coated by a different liquid, then the force balance must be established for all phases involved.

In the case of water, oil gas system, the outer fluid will be assumed to be water, the coating fluid oil and the air is contained inside of the oil layer. Further, for thermodynamic equilibrium, it is assumed that the temperature is constant and the same in all phases. The pressure in the oil phase, P₂, is assumed to be constant also. The water phase will be denoted by w, the oil phase by o and air by a.

Since the force due to the pressure distribution is hydrostatic for stationary bubbles, the force balance on each of the interfaces can be treated individually as given in Eq. (C.1). Thus, at the water oil interface:

$${P}_{2} - {P}_{3} = {P}_{o} - {P}_{w} = \frac{4 {γ}_{wo}}{{d}_{p 2}}$$

Similarly at the oil-air interface:

$${P}_{1} - {P}_{2} = {P}_{a} - {P}_{o} = \frac{4 {γ}_{oa}}{{d}_{p 1}}$$

Hence the pressure differential for an oil-coated bubble is given by:

$${P}_{a} - {P}_{w} = \frac{4 {γ}_{oa}}{{d}_{p 1}} + \frac{4 {γ}_{wo}}{{d}_{p 2}} \qquad ( C .4 )$$

### Surface Tension of Water-Oil Interface:

The surface tension at the interface between two liquids can be estimated from Giriffalco-Good-Fowkes equation (Fowkes, 1945; Kim and Burgess, 2001):

γ_{AB}=γ_{A}+γ_{B}−2\sqrt{γ_{A}^{d}·γ_{B}^{d}} (C.5)

where:
γ_{A}, γ_{B}=surface tension to air for liquids A and B, respectively;
γ_{A}, γ_{B}=dispersion components of A and B, respectively.

Some common quantities are provided in Table C.1.

### Formation of an Oil-Coated Air Bubble:

The relationship given in Eq. (C.4) presupposes that an oil-coated air-bubble can form. It does not establish the necessary condition for the formation, which is a result of a balance of the surface tension forces. The conditions for formation have been discussed extensively in the literature (cf. Goedel, 2003). Consider the formation stages, where an oil droplet starts to spread on an air bubble. The physical situation can be depicted as in the Fig. C.1 below:

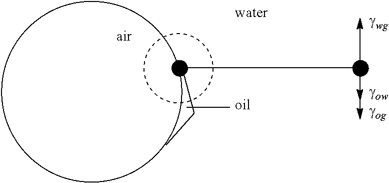

Figure C.1: Schematic representation of oil-coated bubble formation. Left side: thin oil film forming on air bubble; Right side, surface tension forces acting on the system.

The configuration in Fig. C.1 will arise as the oil starts to coat the air bubble. This process will continue (i.e. the oil will spread over the bubble), if the surface tension as shown below will act to pull the junction point towards the non-wetter portion of the bubble, or:

γ_{ow}+γ_{og}−γ_{wg}<0

A more formal proof is obtained by considering an energy statement. The total attractive interaction energy (spreading coefficient) is given by (Zhu et al., 2002; Moosai & Dawe, 2003):

ΔG=γ_{AB}+γ_{A}−γ_{B}=γ_{ow}+γ_{og}−γ_{wg}<0 (C.6)

Thus, if the spreading coefficient is less than zero, spreading will occur. Ss the spreading coefficient becomes increasingly positive, the attractive interaction energy will be such that no spreading will occur. As can be seen in Table C.1, the spreading coefficient is less than zero for lighter hydrocarbons at 20° C. As the temperature increases, however, the surface tension decreases (see Table C.2) and the probability of spreading increases for heavier hydrocarbons as well.

TABLE C.1
Surface tension in air, dispersion coefficients, surface tension
at oil-water interface and total attractive interaction energy (spreading
coefficient) for different hydrocarbons. Units for all values: mN/m.
For water γ_{w}, = 72.8 mN/m, γ^{d}_{w} = 21.9 mN/m.
All quantities given at 20° C.

| Alkane | γₒₐ | γ^{d}ₒ | γ_{wo} | ΔG |
|---|---|---|---|---|
| n-hexane | 18.4 | 18.4 | 51.1 | −3.3 |
| n-octane | 21.8 | 21.8 | 50.9 | −0.1 |
| n-decane | 23.8 | 23.8 | 50.9 | 1.9 |
| n-dodecane | 25.5 | 25.5 | 50.1 | 3.7 |
| n-hexadecane | 28.1 | 28.1 | 51.3 | 6.8 |
| Olive oil | 32.0 | | | |

TABLE C.2
Influence of temperature on surface tension and spreading coefficient.

| | | Temperature | | |
|---|---|---|---|---|
| | γₒₐ | Coefficient | γₒₐ | |
| Alkane | (mN/m @ 20° C.) | mN/m-K | (mN/m @ 60° C.) | ΔG (60° C.) |
| n-hexane | 18.4 | −0.1022 | 14.3 | −6.8 |
| n-octane | 21.8 | −0.0951 | 18.0 | −3.8 |
| n-decane | 23.8 | −0.0920 | 20.1 | −1.8 |
| n-dodecane | 25.5 | −0.0884 | 22.0 | 0.1 |
| n-hexadecane | 28.1 | −0.0854 | 24.5 | 2.7 |
| water | 72.8 | −0.1514 | 66.7 | — |

### REFERENCES

Fowkes, F. M., 1964: “Attractive forces at interfaces,” Ind. Eng. Chem., 56 (40).
Kim, H., Burgess, D. J., 2001: “Prediction of Interfacial Tension between Oil Mixtures and Water,” J. Coll. & Int. Sc. V241, 509-513.
Goedel, W. A., 2003: “A simple theory of particle-assisted wetting,” Eurphys. Lett. 62(4), 607-613.
Moosai, R., Dawe, R. A., 2003: “Gasattachment of oil droplets for gas flotation for oily wastewater cleanup,” Sep. Pur. Tech. 33, 303-314.
Zhu, H., Zhao, F., Tang, J., Li, J., Li, X., Jiang, L., 2002: “Experimental study of oil-water interface layers dilatation rheological properties,” Chinese Science Bulletin, V47 (24), 2056-2059.

1. A process for separating non-dissolved contaminants from contaminated water, said process comprising the steps of:
(a) providing a primary separation tank having an upper section, a lower section, and an interior chamber, said primary separation tank further having:
a.1 a primary outflow port in an upper region of said upper section;
a.2 a primary solids discharge port in a lower region of said lower section;
a.3 a primary clean water discharge port located below said primary outflow port and above said primary solids discharge port; and
a.4 one or more aeration devices disposed at least partially within said interior chamber, each of said aeration devices being adapted to generate gas bubbles smaller than 130 microns in diameter in clean water, and being in fluid communication with a source of a selected aeration gas;
(b) introducing a flow of contaminated water feedstock into the primary separation tank sufficient to submerge the one or more aeration devices;
(c) actuating the one or more aeration devices to generate gas bubbles within the contaminated water in the primary separation tank, in concentrations sufficient to promote formation of a first froth phase above a first liquid phase within the interior chamber;
(d) discharging settled solid contaminants from the primary separation tank through the primary solids discharge port;
(e) discharging portions of said first froth phase, including contaminants adhering thereto, from the primary separation tank through the primary outflow port;
(f) discharging portions of said first liquid phase from the primary separation tank through the primary clean water discharge port; and
(g) balancing flows into and out of the primary separation tank to maintain the interface between the first froth phase and the first liquid phase at a desired elevation.

2. A process as in claim 1 wherein the one or more aeration devices generate a first class of bubbles having diameters of approximately 20 microns and less.

3. A process as in claim 2 wherein the one or more aeration devices generate a second class of bubbles having diameters of between approximately 100 microns and 130 microns.

4. A process as in claim 1 wherein the contaminated water feedstock contains oil.

5. A process as in claim 1 wherein the upper section of the primary separation tank is of conical configuration, and wherein the interface between the first froth phase and the first liquid phase is maintained at a desired elevation within said upper section.

6. A process as in claim 5 wherein the conical upper section of the primary separation tank forms an angle between 45 and 80 degrees from horizontal.

7. A process as in claim 1 wherein the contaminated water feedstock comprises produced water.

8. A process as in claim 1 wherein the aeration gas comprises a gas selected from the group consisting of air, oxygen, and nitrogen.

9. A process as in claim 1, comprising the further steps of:
(a) conveying the first froth phase discharged from the primary separation tank into a secondary separation tank through a primary outflow conduit extending between the primary outflow port of the primary separation tank and a medial region of the secondary separation tank;
(b) allowing the first froth phase conveyed into the secondary separation tank to resolve into a second froth phase overlying a second liquid phase within the secondary separation tank;
(c) discharging settled solid contaminants from the secondary separation tank through a secondary solids discharge port located in a lower section of the secondary separation tank;
(d) discharging portions of said second froth phase, including contaminants adhering thereto, from the secondary separation tank through a secondary outflow conduit connected to an upper section of the secondary separation tank;
(e) discharging portions of said second liquid phase from the secondary separation tank through a secondary clean water discharge port located below said secondary outflow conduit and above said secondary discharge port; and
(f) balancing flows into and out of the secondary separation tank to maintain the interface between the second froth phase and the second liquid phase interface at a desired elevation.

10. A process as in claim 9 wherein the upper section of the secondary separation tank is of conical configuration, and wherein the interface between the second froth phase and the second liquid phase is maintained at a desired elevation within said upper section of the secondary separation tank.

11. A process as in claim 10 wherein the conical upper section of the secondary separation tank forms an angle between 45 and 80 degrees from horizontal.

12. A process as in claim 9 comprising the further steps of:
(a) providing one or more supplementary aeration devices disposed at least partially within the interior of the secondary separation tank, each of said supplementary aeration devices being adapted to generate gas bubbles smaller than 50 microns in diameter in clean water, and being in fluid communication with the source of a selected aeration gas, the location of said one or more supplementary aeration devices being selected such that they will be immersed in the second liquid phase; and
(b) actuating said one or more supplementary aeration devices to generate gas bubbles within the second liquid phase in the secondary separation tank.
